(19) United States
(12) Patent Application Publication
(10) Pub. No.: US 2023/0108404 A1
(43) Pub. Date: Apr. 6, 2023

(54) SYSTEM INCLUDING CAVITATION IMPELLER AND TURBINE

(71) Applicant: Micro-Combustion, LLC, Chicago, IL (US)

(72) Inventors: Davis Anderson, Chicago, IL (US); Tyler Erickson, Chicago, IL (US)

(73) Assignee: Mico-Combustion, LLC, Chicago, IL (US)

(21) Appl. No.: 17/902,149

(22) Filed: Sep. 2, 2022

Related U.S. Application Data
(60) Provisional application No. 63/243,891, filed on Sep. 14, 2021.

(51) Int. Cl. F03B 3/18; F04D 31/00; F03B 11/00

(52) U.S. Cl. CPC F03B 3/18; F03B 11/002; F04D 31/00; F05D 2240/31

(57) ABSTRACT

The invention relates generally to a system and in particular to a waste heat recovery system including one or more cavitation impellers and turbines. The system may include one or more impellers that are configured to generate pressure, flow, and cavitation bubbles, which, upon collapsing, release energy that may be captured by the output turbine. Advantageously, the system can harness the captured energy to, for example, turn a crankshaft to add torque or operate a generator to charge an external power source.

### CROSS-REFERENCE TO RELATED APPLICATION

This application claims benefit of U.S. Application No. 63/243,891 filed on Sep. 14, 2021, which is incorporated by reference in its entirety.

### FIELD OF THE INVENTION

The invention relates generally to a system including a cavitation impeller and turbine, for uses that may include waste heat recovery, and more particularly, a system including one or more cavitation impellers and turbines.

### BACKGROUND

Internal combustion engines are often used to power, for example, vehicles, ships, airplanes, trains, generators, and other types of machinery. Examples of internal combustion engines include gasoline engines, diesel engines, gas turbines, jet engines, and rocket engines.

Typically, internal combustion engines generate heat as a result of inefficiencies associated with converting fuel into energy. As heat represents energy potential, it is often desirable to recover energy from the heat for conversion into mechanical and/or electrical power. This recovery may improve performance, enhance the fuel efficiency of the vehicle, and reduce harmful emissions.

Traditional waste heat recovery systems are often configured to recover heat from a high temperature source, such as an exhaust. Such traditional systems may include components that extract the heat from, for example, the exhaust gas produced by an internal combustion engine, particularly if sufficient pressure (above atmospheric) is present in the exhaust gas. Example components of traditional waste heat recovery systems may include exhaust gas recirculation (EGR) boilers, pre-charge air coolers (pre-CAC), exhaust system heat exchangers or other components configured to extract heat.

However, traditional waste heat recovery systems are susceptible to failures. For example, traditional systems often develop mechanical malfunctions and/or leakages due to, for example, corrosion or fatigue. Such malfunctions are often difficult and costly to repair. Also, traditional waste heat recovery systems are often inefficient. Inefficiencies of traditional systems may be caused by heat loss, frictional loss, and unharnessed work.

Therefore, there is a need for a system that is more efficient, smoother running, and less susceptible to malfunctions, in uses such as waste heat recovery. The present invention satisfies this need.

### BRIEF DESCRIPTION OF THE DRAWINGS

Embodiments are illustrated by way of example and not limitation in the figures in the accompanying drawings, in which like references indicate similar elements and in which:

FIG. 1A illustrates a top perspective view of an exemplary system for uses such as waste heat recovery;

FIG. 1B illustrates a bottom perspective view of the exemplary system of FIG. 1A;

FIG. 1C illustrates a front view of the exemplary system of FIG. 1A;

FIG. 1D illustrates a sectional view of the exemplary system of FIG. 1A;

FIG. 2A illustrates a perspective view of another exemplary system;

FIG. 2B illustrates a front view of the exemplary system of FIG. 2A;

FIG. 2C illustrates a side view of the exemplary system of FIG. 2A;

FIG. 2D illustrates a sectional view (2D-2D) of the exemplary system of FIG. 2A;

FIG. 3A illustrates a perspective view of yet another exemplary system;

FIG. 3B illustrates a front view of the exemplary system of FIG. 3A;

FIG. 3C illustrates a side view of the exemplary system of FIG. 3A;

FIG. 3D illustrates a sectional view (3D-3D) of the exemplary system of FIG. 3A;

FIG. 4A illustrates an front perspective view of exemplary impeller of a system;

FIG. 4B illustrates a back perspective view of the exemplary impeller of FIG. 4A;

FIG. 4C illustrates a front view of the exemplary impeller of FIG. 4A;

FIG. 4D illustrates a side view of the exemplary impeller of FIG. 4A;

FIG. 5A illustrates a perspective view of an exemplary output turbine of a system; and

FIG. 5B illustrates a top view of the exemplary output turbine of FIG. 5A.

FIG. 6A illustrates a perspective view of yet another exemplary system;

FIG. 6B illustrates a rear view of the exemplary system of FIG. 6A;

FIG. 6C illustrates a sectional view of the exemplary system of FIG. 6A;

FIG. 6D illustrates a side view of the exemplary system of FIG. 6A;

FIG. 6E illustrates a front view of the exemplary system of FIG. 6A;

FIG. 7A illustrates an exemplary impeller of a system;

FIG. 7B illustrates a front view of the exemplary impeller of FIG. 7A;

FIG. 7C illustrates a side view of the exemplary impeller of FIG. 7A;

FIG. 8A illustrates an exemplary turbine blade assembly of a system;

FIG. 8B illustrates a rear view of the exemplary turbine blade assembly of FIG. 8A;

FIG. 8C illustrates a front view of the exemplary turbine blade assembly of FIG. 8A;

FIG. 8D illustrates a side view of the exemplary turbine blade assembly of FIG. 8A;

FIG. 9A illustrates a perspective view of an exemplary jet turbine of a system; and

FIG. 9B illustrates a top view of the exemplary jet turbine assembly of FIG. 9A.

### DETAILED DESCRIPTION OF THE INVENTION

The invention relates generally to a system and in particular to a waste heat recovery system including one or more cavitation impellers and turbines. As detailed below, impellers of the system are configured to generate pressure, flow, and cavitation bubbles, which, upon collapsing, release energy that may be captured by the output turbine. Advantageously, the system can harness the captured energy to, for example, turn a crankshaft to add torque or operate a generator to charge an external power source, such as a battery.

### Exemplary Systems

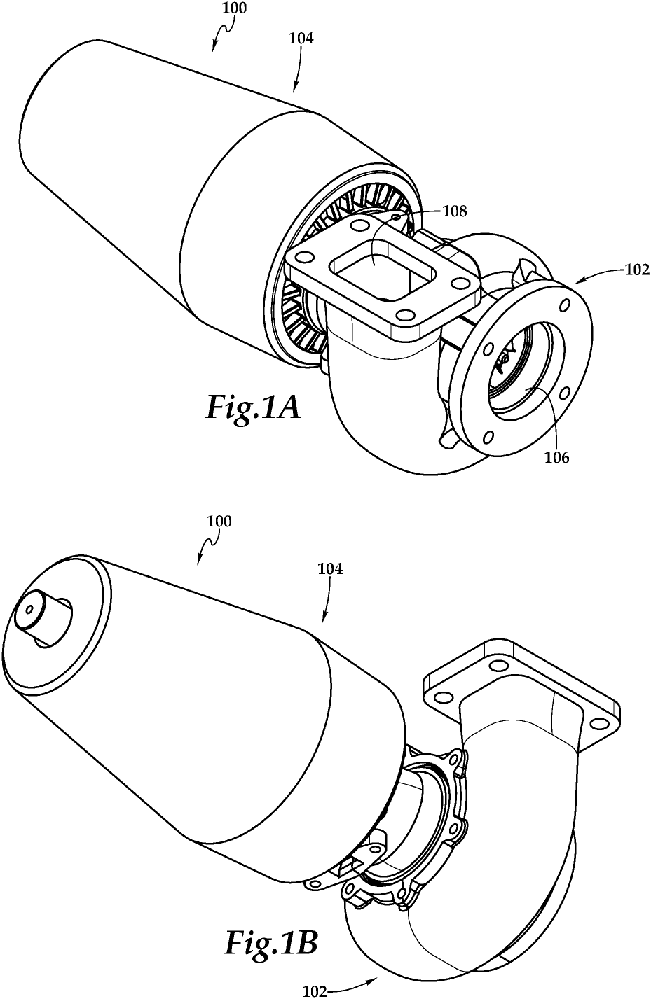

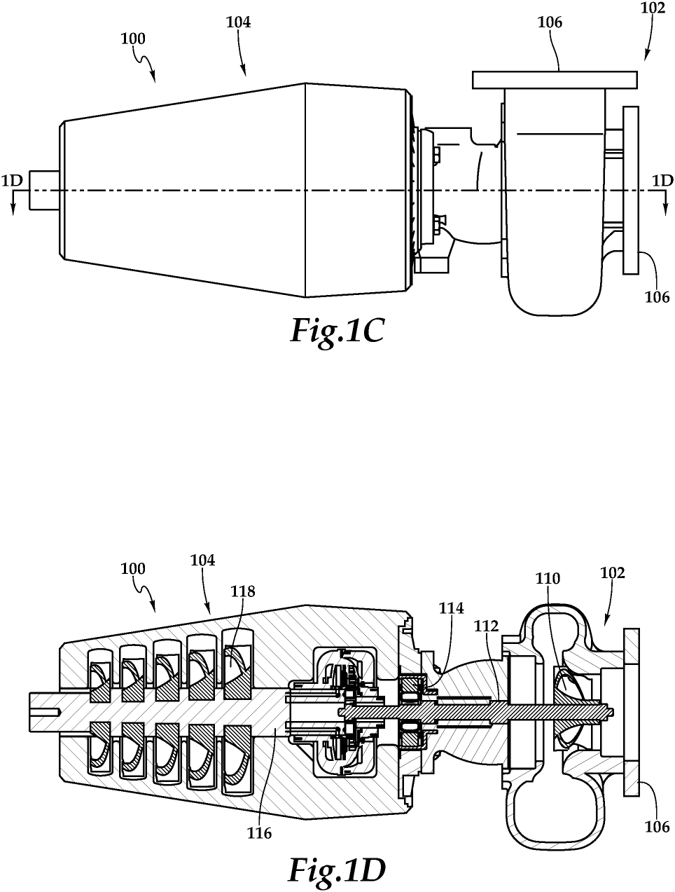

Turning now to the drawings wherein like numerals represent like components, FIGS. 1A-1D illustrate an exemplary system 100. One or more portions of system 100 may be constructed from metals and/or alloys, such as stainless steel, cobalt-chrome alloy, titanium, and nickel-titanium alloy.

As shown in FIGS. 1A-1C, system 100 may include an exhaust turbine housing 102 having a turbine wheel 110 connected to one or more cavitation impellers 114 of a cavitation chamber 104, which may also be referred to as an expansion chamber. While chamber 104 is shown as substantially conical shaped, other shapes are contemplated.

As illustrated, housing 102 may include an exhaust outlet 106 and an exhaust inlet 108. As shown in FIG. 1D, housing 102 may include turbine wheel 110. Turbine wheel 110 may be driven by hot exhaust gases, which are directed through the exhaust inlet 108. The exhaust inlet 108 may receive exhaust energy from, for example, a combustion chamber of an internal combustion engine (not shown).

As illustrated in FIG. 1D, turbine wheel 110 may be connected to an auxiliary shaft 112. As shown, auxiliary shaft 112 may extend from exhaust outlet 106 into chamber 104 and couple with cavitation impeller 114. One or more output turbine blades 118 may couple to a drive shaft 116. As shown, auxiliary shaft 112 and drive shaft 116 may be separate components to facilitate applying variable speed and power from output turbine blades 118 to an external drive unit (not shown), such as a gear box or generator. It is further contemplated that shafts 112, 116 may be a single component in certain embodiments.

In operation, as cavitation impeller 114 receives rotational input from the auxiliary shaft 112, cavitation bubbles and fluid flow may be transferred to the output turbine blades 118, which may result in fluid flow and cavitation micro-combustion for turning drive shaft 116. As drive shaft 116 is turned, power may be generated and transmitted to, for example, an output device such as a gear box or generator. For purposes of this application, the term fluid refers to a liquid, gas, and combinations of both.

As shown in FIG. 1D, one or more output turbine blades 118 are mounted on drive shaft 112 and distributed throughout chamber 104. Output turbine blades 118 may be configured to create pressure and direct the flow of a fluid within chamber 104. While not shown, it is contemplated that system 100 may include one or more inlets for injecting at least one of air and/or additional fluid into chamber 104.

Impeller 114 also may be accelerated at a high velocity to generate cavitation and form bubbles within the fluid. While system 100 of FIG. 1D is shown to have one impeller 114, any number of impellers is contemplated.

More specifically, cavitation may be produced when the local pressure in the fluid drops due to the high local velocity of impeller 114. When the local pressure of the fluid drops below its vapor pressure, bubbles in the fluid may expand as the internal bubble volume fills with fluid vapor.

As each bubble expands to a critical diameter and the pressure drop is suddenly released, such as when the fluid passes into chamber 104, the pressure suddenly increases, and in combination with the surface tension forces on a surface of the bubbles, a rapid collapse of the bubble diameter may occur. When this collapse happens with sufficient intensity, the pre-collapse/collapse compression ratio can range from about 1000:1 to about 3000:1. This may facilitate producing a high temperature (e.g., several thousand Kelvin) inside the bubble, which may then ignite the bubble air fuel mixture and/or excite the bubble molecular bond particles decomposition.

Following the cavitation ignition process, the contents of the bubble interior may combust to release heat energy for oxidative combustion and/or molecular decomposition. The energy from the implosion of bubbles may be harnessed and transmitted to a pulley or gear assembly (not shown) via drive shaft 116 to, for example, add torque to a vehicle by turning a crankshaft or charge an external power source.

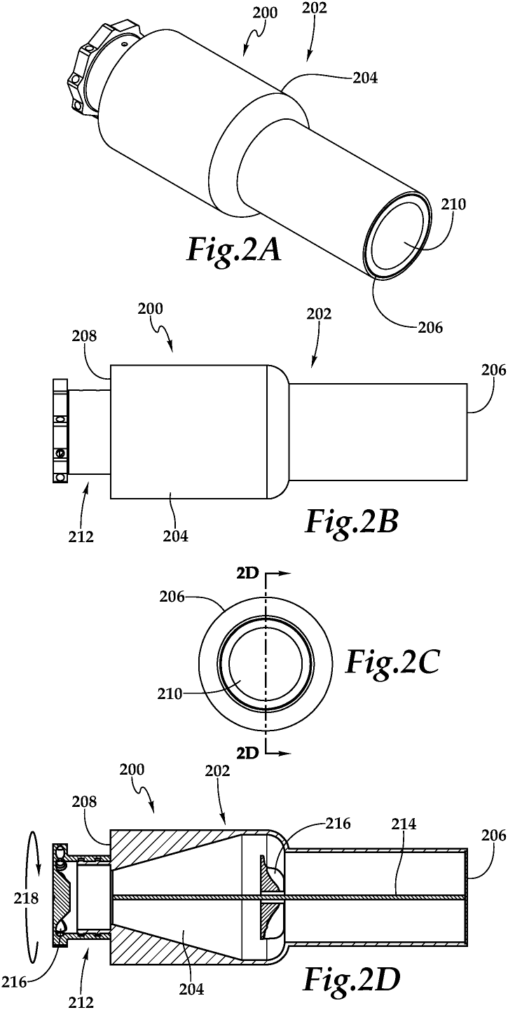

FIGS. 2A-2D illustrate another exemplary system 200. As shown, system 200 may include a substantially cylindrical housing 202 including a chamber 204. It is contemplated that housing 202 and chamber 204 may be constructed from the same materials or from different materials including, for example, metals and/or alloys, such as stainless steel, cobalt-chrome alloy, titanium, and nickel-titanium alloy.

As shown in FIGS. 2A-2B, housing 202 may include a first end 206 and a second end 208. First end 206 may include an opening for fuel and combustion air inlet 210 (FIG. 2C). Further, first end 206 may be configured to couple with, for example, an auxiliary turbine attached to an internal combustion engine that emits exhaust gases such as in FIG. 1A. Second end 208 of housing 202 may include an output turbine 212, which may couple with chamber 204 and be configured to harness and transmit energy, as detailed below.

As shown in FIG. 2D, a drive shaft 214 may extend through housing 202 and into or through chamber 204. Similar to the operation described above with reference to exemplary system 100, drive shaft 214 of system 200 may receive rotational input as a result of, for example, the exhaust gases emitted through the internal combustion engine and directed to a turbine — which may be similar to turbine wheel 110 of FIG. 1A — coupled to drive shaft 214.

As illustrated, one or more impellers 216 may be rotatably mounted on drive shaft 214. In operation, impeller 216 may be driven by drive shaft 214 to create pressure and direct flow of fluid within housing 202. While system 200 is shown to have one impeller 216, any number of impellers is contemplated.

As the fluid flows through chamber 204, the rotation of impeller 216 may generate cavitation bubbles. As described above with reference to system 100, the cavitation bubbles may combust to release heat energy without reversing the fluid flow. The release of heat energy may then be harnessed by the output turbine 212.

As shown, output turbine 212 may be rotatably supported by one or more bearing supported by chamber 204. Moreover, output turbine 212 may include one or more exit ports 216 through which heated/energized fluid is released, thereby creating a rotational force 218. This rotational force 218 may then be transferred to, for example, an output shaft that may couple with a crankshaft or an alternator/generator creating useable energy from waste heat and pressure.

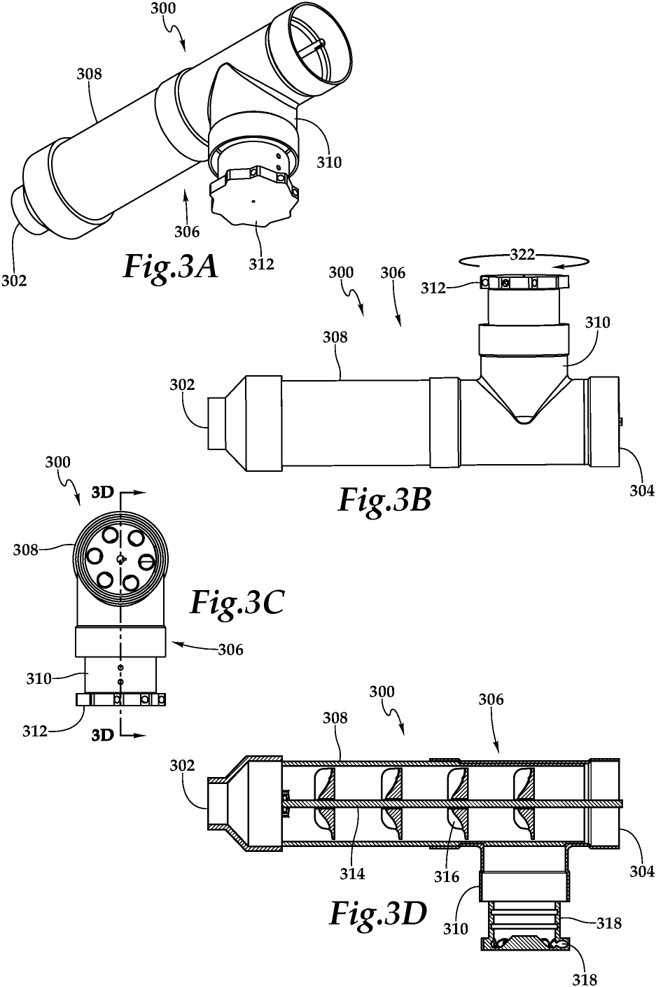

FIGS. 3A-3D illustrate another exemplary system 300. As shown, system 300 may include a first end 302 and a second end 304. First end 302 may be configured to receive energy, e.g., exhaust energy, from one or more sources, such as an internal combustion engine.

As illustrated, chamber 306 may include a longitudinal portion 308 and a transverse portion 310. Chamber 306 may be configured to contain a fluid, such as a liquid, gas, and combinations of both. In certain embodiments, chamber 306 may be coupled to a fluid reservoir (not shown).

Although system 300 is not limited to specific dimensions, a length of chamber 306 may range between about eight inches and about twenty four inches, and preferably between about ten and about sixteen inches. A diameter of chamber 306 may range between about three inches and about fifteen inches, and preferably between about four and about ten inches. A wall thicknesses of chamber 306 may be about a quarter inch, about half an inch, about three quarters of an inches, about an inch and a half, about two and a half inches, about three and a half inches or about four inches. Moreover, while the angle between longitudinal portion 308 and transverse portion 310 is shown to be substantially normal, other angles between the two portions 308, 310 are contemplated.

As shown in FIG. 3D, longitudinal portion 308 of chamber 306 may include a drive shaft 314 that may be configured to extend out through second end 304 of system 300. One or more impellers 316 may be rotatably mounted on drive shaft 314 and distributed throughout chamber 306. Drive shaft 314 may be coupled to an auxiliary turbine or gear assembly at end 304, such as auxiliary shaft 112 and gear assembly 114 of FIG. 1, and configured to receive fuel and/or air via the first end 302. As system 300 receives rotational input, drive shaft 314 may drive one or more impellers 316. While system 300 is shown to have four impellers 316 in FIG. 3D, any number of impellers is contemplated.

As detailed above, impellers 316 may be accelerated at a high velocity to generate cavitation and form bubbles within the fluid. Moreover, impellers 316 may be configured to create pressure and direct the flow of a fluid to transverse portion 310 of chamber 306.

An output turbine 312 may be rotatably coupled to transverse portion 310. More specifically, output turbine 312 may include a recessed segment or channels 318 having roller or ball bearings to sealably and securely couple to transverse section 310. Moreover, output turbine 312 may include one or more exit ports 320 through which heated/energized fluid is released, thereby creating a rotational force 322. This rotational force 322 may then be transferred to, for example, an output shaft that could be coupled to a crankshaft or an alternator/generator creating useable energy from waste heat and pressure.

While not shown, the systems described herein, such as systems 100, 200, 300, may include a number of sensors and actuators that facilitate various functions. Examples of sensors may include RPM sensors, pressure sensors, temperature sensors, and mass air flow sensors. Examples of actuators may include wastegate valve actuators, metering actuators, relief valves, pressure valves, bleed valves, bypass loops, de-aeration loop metering valves, and air inlet.

In addition, systems may include a processor, which may be a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, any conventional processor, controller, microcontroller, or state machine. A general purpose processor may be considered a special purpose processor while the general purpose processor is configured to execute instructions (e.g., software code) stored on a computer readable medium. A processor may also be implemented as a combination of computing devices, such as a combination of a DSP and a microprocessor, a plurality of microprocessors, one or more microprocessors in conjunction with a DSP core, or any other such configuration.

A processor of a system may be configured to receive inputs and issue output signals. The output signals produced by processor may be to a component of the system. In certain embodiments, the processor may be configured to send one or more control signals to an actuator based on input signals received from sensors to, for example, control air/fuel ratio, cavitation rate, heat release, impeller input speed etc.

### Exemplary Impeller

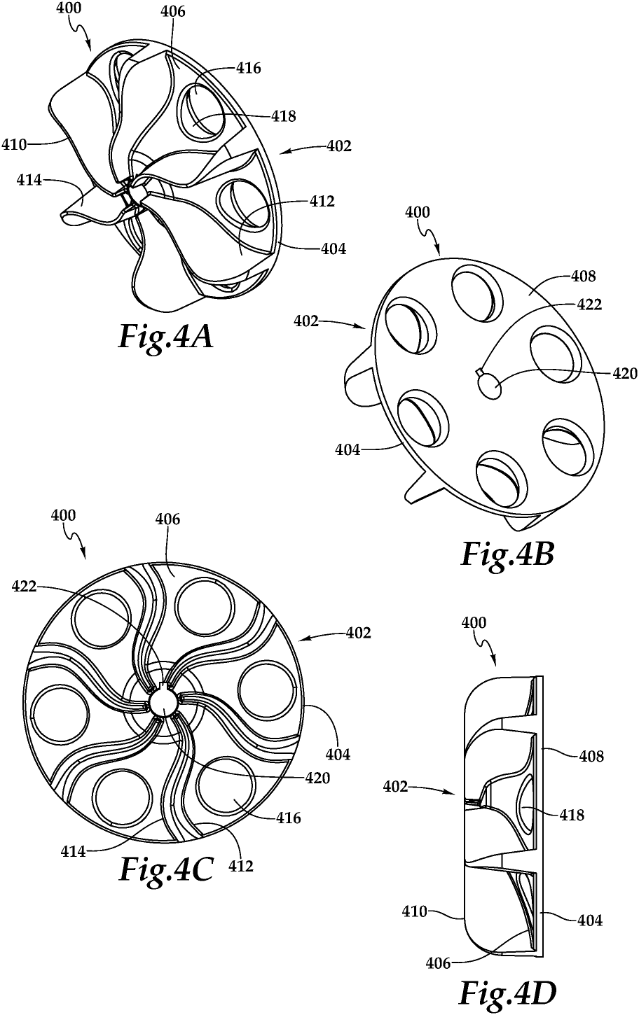

FIGS. 4A-4D illustrate an exemplary impeller 400 of a system. As shown, impeller 400 has a body 402 defined by an edge 404. Body 402 may include a front surface 406 and a back surface 408.

A diameter of body 402 may range between about two inches and about fifteen inches, and preferably between about three inches and about ten inches. In certain embodiments, the diameter of body 402 is about three and three-quarter inches. While body 402 of impeller 400 is shown to be substantially circular, other shapes are contemplated.

As shown in FIG. 4A and FIG. 4C, one or more blades 410 may extend outwardly from front surface 406 of body 402. Blades 410 may be designed to induce cavitation within a system, such as the systems described herein. The height of each blade 410 extending from front surface 406 may range between about half an inch and about three inches, and preferably between about one inch and about two inches. As shown, blades 410 may be curved blades defining concave surfaces 412 and convex surfaces 414. While illustrated as curved blades, other shapes and styles are contemplated, such as straight blades.

As shown in FIG. 4A, impeller 400 may include one or more apertures 416. Apertures 416 may allow pressure equalization and fluid flow, thereby further facilitating generating cavitation within a chamber, such as the cavitation chamber of FIGS. 1A-3D. As illustrated, apertures 416 may be substantially circular in shape and further defined by a raised member 418 extending from front surface 406.

As shown in FIG. 4B and FIG. 4D, back surface 408 may be substantially flat or planar. A central opening 420 may extend from front surface 406 to back surface 408, as shown in FIG. 4B.

As shown in FIG. 4C, each blade 410 of impeller 400 may be configured to extend from opening 420 to edge 404. Opening 420 may be configured to receive, for example, a drive shaft. More specifically, opening 420 may include a dimple 422 such that impeller 400 may be rotatably mounted on the drive shaft.

### Exemplary Output Turbine

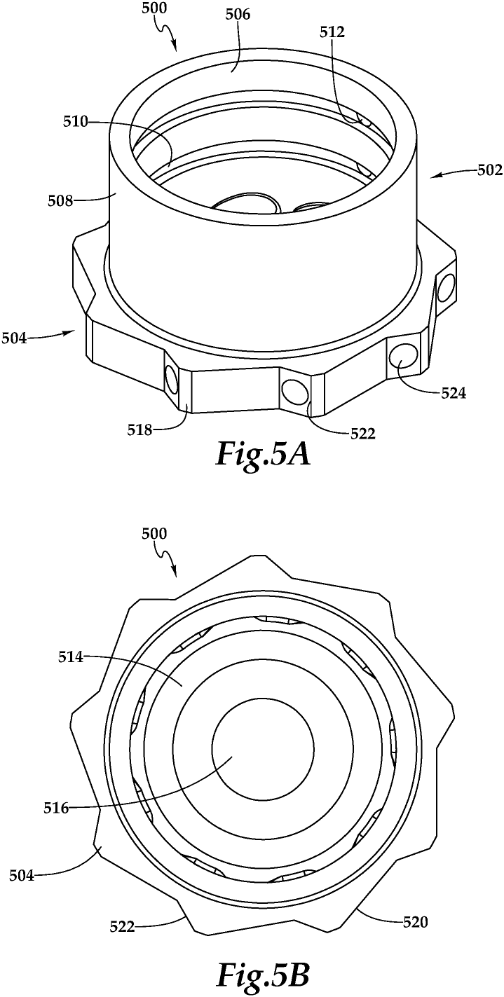

FIGS. 5A-5B illustrate an exemplary output turbine 500 of a system. A height of turbine 500 may range between about one inch and about five inches, and preferably between about two inches and about four inches. A width of turbine 500 may range between about two inches and about six inches, and preferably between about four inches and about five inches.

As shown, output turbine 500 has a top member 502 and a bottom member 504. Top member 502 may include an interior surface 506 and a smooth cylindrical exterior surface 508. A diameter of exterior surface 508 may range between about two inches and about six inches, and preferably between about three and about five inches. While top member 502 of output turbine 500 is shown to be substantially cylindrical, other shapes are contemplated.

As illustrated in FIG. 5A, interior surface 506 of top member 502 may include one or more channels 510. One or more bearings 512 may be fitted within each channel 510 to facilitate rotational movement of turbine 500. Examples of bearings 512 may include roller bearings or ball bearings. Through use of bearings 512, top member 502 may be rotatably coupled to, for example, a cavitation chamber such that energy from the implosion of bubbles may be captured and harnessed by output turbine 500.

As shown in FIG. 5A and FIG. 5B, bottom member 504 includes a core section 514 having a top surface 516 coupled to top member 502. As illustrated, one or more fins 518 may extend outwardly from an edge 513 of core section 514. Each fin 518 may be defined by an elongated section 520 and an abridged section 522. Each abridged section 522 may include a port 524. Port 524 may be configured to provide an outlet of a fluid, such as a fluid within a cavitation chamber. More specifically, ports 524 may facilitate rotation of turbine 500 at high RPM due to the jet ports spraying out the energized fluids. Fluid that dispenses through ports 524 may be conveyed to, for example, a fluid reservoir that can reintroduce the collected fluid into a system, such as a system.

As discussed above, outlet turbine 500 may be configured to capture energy released from the implosion of bubbles. The energy transmitted through output turbine 500 may then be harvested and transferred to, for example, an output shaft that could be coupled to a crankshaft or an alternator/generator creating useable energy from waste heat and pressure.

### Exemplary System and Testing of Same

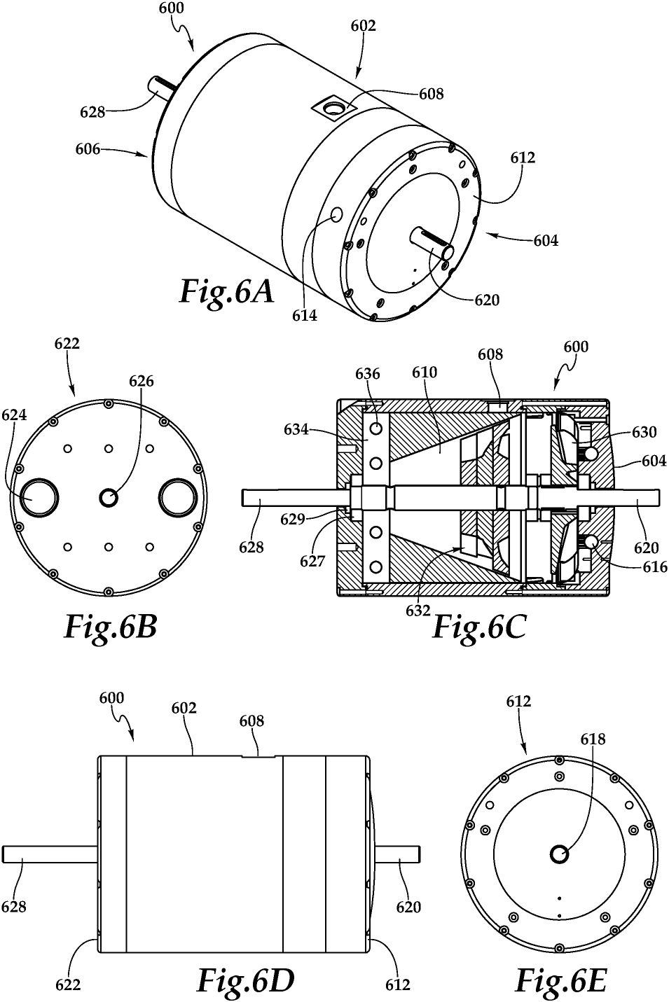

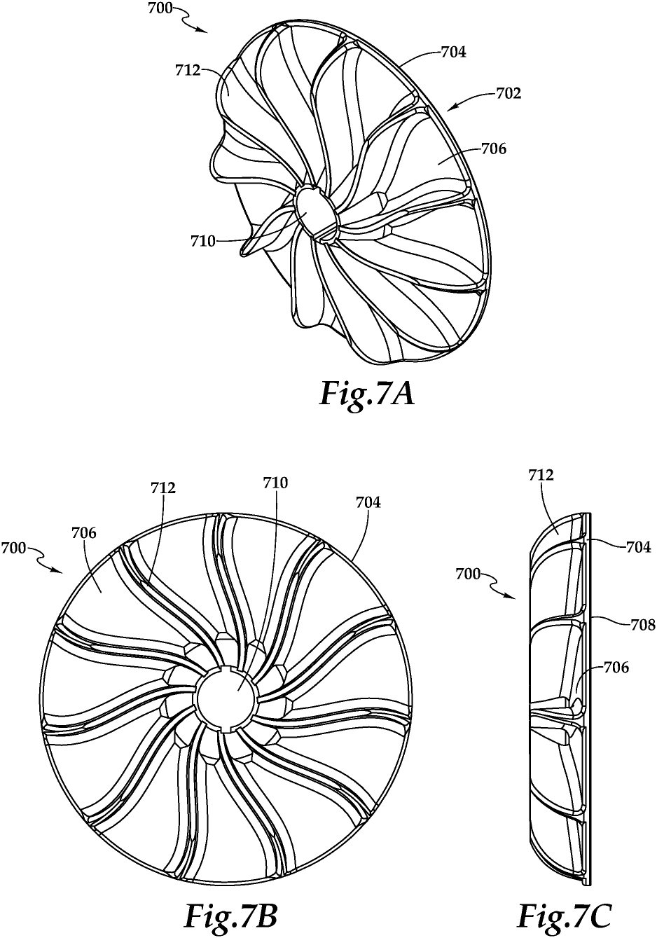

FIGS. 6A-6E illustrate an exemplary system 600. A length of system 600 may range between about fifteen inches and about forty inches, and preferably between about twenty inches and about thirty inches. In certain embodiments, system 600 may be about twenty-five and a half inches in length.

As shown, system 600 may include a housing 602 having a front end 604 and a rear end 606. Further, housing 602 may include an observation port 608 positioned to, for example, provide an unobstructed view into a cavitation chamber 610 (FIG. 6C), as detailed below.

Although housing 602 is not limited to specific dimensions, a length of housing 602 may range between about ten inches and about thirty inches, and preferably between about fifteen inches and about twenty inches. In certain embodiments, housing 602 may be about sixteen and a half inches in length. A diameter of housing 602 may range between about five inches and about fifteen inches, and preferably about twelve inches. While housing 602 is shown to be substantially cylindrical, other shapes are contemplated.

As illustrated in FIG. 6A and FIG. 6E, front end 604 may include an inlet cap 612 having an inlet 614. A fuel gallery 616 (FIG. 6C) of inlet cap 612 may receive and guide a fluid — such as a liquid, gas, and combinations of both — fed through inlet 614. While one inlet is shown in FIG. 6A, it is contemplated that inlet cap 612 may include any number of inlets. Further, inlet cap 612 may include an opening 618 configured to receive an input shaft 620.

Although not shown, it is contemplated that system 600 may further include one or more glow plugs. Glow plugs may be a pencil-shaped piece of metal with a heating element at the tip. This heating element, when electrified, heats due to its electrical resistance and begins to emit light in the visible spectrum. As a result, fuel that impinges directly upon the hot tip of the glow plug may ignite.

As shown in FIGS. 6A-6B, rear end 606 may include an exhaust end cap 622 having one or more exhaust ports 624. Exhaust ports 624 may be connected to the inlet port, ports or fuel gallery, to achieve internal recirculation of fluids and gases. While two exhaust ports 624 are shown, it is contemplated that end cap 622 may include any number of exhaust ports. End cap 622 may be configured to releasably couple with housing 602 such that each exhaust port 624 may provide a conduit through which exhaust gases can escape. Exhaust end cap 622 may further include an opening 626 configured to receive an output (or drive) shaft 628.

FIG. 6C illustrates a sectional view of system 600. As shown, input shaft 620 may extend through opening 618 into housing 602 and couple with output shaft 628. Both shafts 620, 628 may be supported by bearings 627 and rotary seals 629 to, for example, prevent leakage of a fluid out of the housing 602. Input shaft 620 and output shaft 628 may be separate components to facilitate applying variable speed and power to an external drive unit, such as a gear box or generator. It is further contemplated that shafts 620, 628 may be a single component in certain embodiments.

Input shaft 620 may rotatably support a cavitation impeller 630 having a plurality of blades. For example, impeller 630 may have anywhere between about five blades and about thirty blades. Impeller 630 may be configured to receive rotational input from shaft 620. In operation, as a fluid is fed through inlet 614, impeller 630 may be accelerated at a high velocity to generate cavitation and form bubbles within the fluid. Moreover, impellers 630 may be configured to create pressure and direct the flow of a fluid to the cavitation chamber 610, which may also be referred to as an expansion chamber.

As shown in FIG. 6C, cavitation chamber 610 may be shaped to resemble a Venturi cone having, for example, a mouth portion, a throat portion, and a discharge portion. Furthermore, chamber 610 may include an turbine blade assembly 632 having one or more turbine blades. For example, as shown, turbine blade assembly 632 may include three output sigmoid, tapered turbines structured to fit a cone shaped chamber, such as chamber 610. In other words, a first turbine may have a smaller diameter compared to a second turbine, which may have a smaller diameter compared to a third turbine. Output turbine blade assembly 632 may be rotatably mounted on output shaft 628. As detailed below, output turbine blades 632 may include a plurality of blades that may be configured to turn output shaft 628 as a result of fluid flow and cavitation micro-combustion.

Further, an output jet turbine 634 may be rotatably mounted by output shaft 628. Output jet turbine 634 may be sealably and securely couple to exhaust end cap 622. Moreover, output jet turbine 634 may include one or more exit ports 636 through which heated/energized fluid is released, thereby creating a rotational force. This rotational force may then be transferred to, for example, an output shaft that could be coupled to a crankshaft or an alternator/generator creating useable energy from waste heat and pressure.

As detailed above, the system may produce cavitation when the local pressure in the fluid drops due to the high local velocity of impeller 630. When the local pressure of the fluid drops below its vapor pressure, bubbles in the fluid may expand as the internal bubble volume fills with fluid vapor. Then, as each bubble passes into chamber 610, an increase in pressure combined with the surface tension may result in a rapid collapse of the bubble diameter. Because of this rapid collapse, the contents of the bubble interior may combust to release heat energy for oxidative combustion and/or molecular decomposition. The energy from the implosion of bubbles may be harnessed via output shaft 628 and transmitted to, for example, turn a crankshaft or charge an external power source.

FIGS. 7A-7C illustrate an exemplary cavitation impeller 700, which may be the same or similar to cavitation impeller 630 of system 600. As shown, impeller 700 has a body 702 defined by an edge 704. Body 702 may include a front surface 706 and a back surface 708, which may be substantially flat or planar.

A radius of body 702 may range between about two inches and about eight inches, and preferably between about three inches and about five inches. In certain embodiments, a radius of body 702 is about four and nine-tenths inches. While body 402 of impeller 400 is shown to be substantially circular, other shapes are contemplated.

Body 702 of impeller 700 may further include a central opening 710, which may be configured to receive an input shaft, such as input shaft 620 of system 600. Opening 710 may extend from front surface 706 to back surface 708. In particular, a radius of opening 710 may range between about a quarter of an inch and about one inches. In certain embodiments, a radius of opening 710 is about three quarters of an inch.

As shown in FIGS. 7A-7C, one or more blades 712 may extend outwardly from front surface 706 of body 702. For example, impeller 700 may have anywhere between about five blades and about thirty blades. In certain embodiments, impeller may be configured to have nine, eleven, thirteen or twenty-one blades, as further detailed in the examples below.

Blades 712 may be designed to induce cavitation within a system, such as the systems described herein. The height of each blade 712 extending from front surface 706 may range between about half an inch and about three inches, and preferably between about one inch and about two inches. In certain embodiments, a height of each blade 712 extending from fronts surface may be about one and six tenths inches. As shown, blades 710 may be curved. Other shapes and styles of blades are contemplated, such as straight blades.

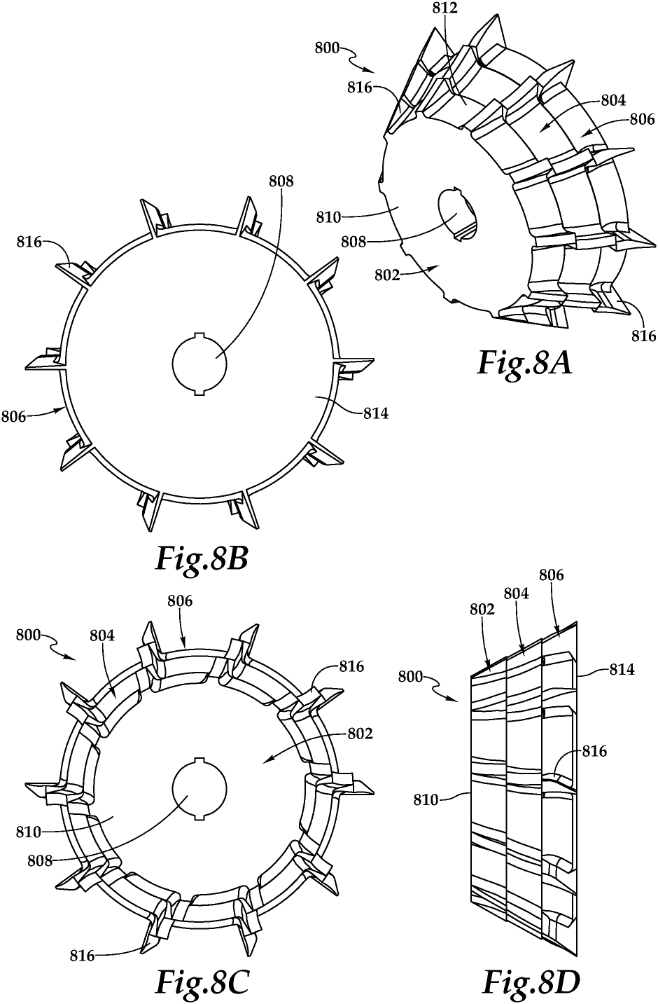

FIGS. 8A-8D illustrate an exemplary turbine assembly 800, which may be the same or similar to output turbines 632 of system 600. As illustrated, turbine assembly 800 may include a first turbine 802, a second turbine 804, and a third turbine 806. Turbine unit 800 may have a sigmoid, curved or tapered design such that a diameter of first turbine 802 may be smaller than a diameter of second turbine 804, which may have a smaller diameter compared to third turbine 806.

A height of turbine assembly 800 may range between about three inches and about fifteen inches, and preferably between about five inches and about ten inches. A width of turbine assembly 800 may range between about one inch and about twenty inches, and preferably between about two inches and about ten inches.

As shown, each turbine 802, 804, 806 may be substantially circular and include a front surface 810, a side surface 812, and a rear surface 814. Font surface 810 and rear surface 814 may be substantially flat or planar.

Further, turbine assembly 800 may be structured such that each turbine 802, 804, 806 is aligned to define an opening 808. Opening 808 may be configured to receive an output shaft, such as output shaft 628 of system 600. A radius of opening 808 may range between about a quarter of an inch and about one inches. In certain embodiments, a radius of opening 814 is about three quarters of an inch.

As shown in FIGS. 8A-8D, side surface 812 of each turbine 802, 804, 806 may include one or more blades 816 extending from side surface 812. A height of blades 816 from side surface 816 may range between about a quarter of an inch and about five inches, and preferably between about half an inch and about three inches. Further, blades 816 of turbine assembly 800 may structured to reduce any dead volume by, for example, progressively decreasing in height between each turbine 802, 804, 806. For instance, blades 816 of first turbine 802 may extend out about half an inch, blades 816 of second turbine 804 may extend out about six tenths of an inch, and blades 816 of third turbine 806 may extend out about one inch. As shown in FIG. 8D, based on this configuration, when aligned, the blades 816 of each turbine 802, 804, 806 may appear to form a single curved and/or tapered blade.

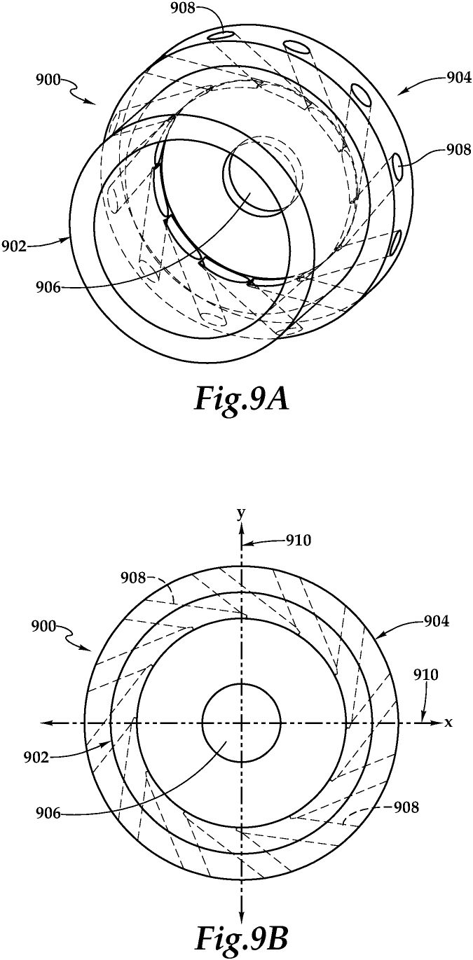

FIGS. 9A-9B illustrate an exemplary output jet turbine 900, which may be the same or similar to output jet turbine 634 of system 600. Output jet turbine 900 may include a top member 902 extending outwardly from a bottom member 904.

Top member 902 may be substantially cylindrical. A height of top member 902 may range between about two inch and about five inches, and preferably between about three inches and about four inches. A diameter of top member 902 may range between about two inches and about eight inches, and preferably between about four inches and about six inches. In certain embodiments, top member 902 may have a diameter of about five inches.

Bottom member 904 may be substantially circular and configured to have a diameter that is larger than the diameter of top member 902. More specifically, a diameter of bottom member 904 may range between about three inches and about nine inches, and preferably between about five inches and about seven inches. In certain embodiments, bottom member 904 may have a diameter of about six inches. Further, a height of bottom member 904 may range between about half an inch and about two inches, and preferably between about three quarters of an inch and about an inch and a quarter. In certain embodiments, bottom member 904 may have a height of about one inch.

As shown in FIG. 9A and FIG. 9B, bottom member 904 may include an opening 906 configured to receive, for example, an output shaft such as output shaft 628 of system 600. Further, bottom member 904 may include a plurality of exit ports 908. A diameter of exit ports 908 may range between about a quarter of an inch and about three quarters of an inch, and preferably be about half of an inch.

Exits ports 908 may be angled in relation a plane 910 of bottom member 904 to, for example, facilitate rotation of jet turbine 900. For instance, an angle of exits ports 908 in relation to an x-axis of plane 910 may range between about twenty degree and about fifty degrees, and preferably between about thirty degrees and about forty degrees. Further, an angle of exit ports 908 in relation to a y-axis of plane 910 may range between about one hundred and twenty degrees and about one hundred and sixty degree, and preferably between about one hundred and thirty degree and about one hundred and fifty degrees. In operation, exit ports 908 spray out an energized fluid that cause jet turbine 900 rotate at a high RPM. Fluid that dispenses through ports 908 may be conveyed to, for example, a fluid reservoir that can reintroduce the collected fluid into a system, such as a system.

As detailed above, jet turbine 900 may be configured to capture energy released from the implosion of bubbles. The energy transmitted through jet turbine 900 may then be harvested and transferred to, for example, an output shaft that could be coupled to a crankshaft or an alternator/generator creating useable energy from waste heat and pressure.

### Example 1: Nine Blade Impeller with Three Blade Tapered Turbine

A speed sweep test was performed with varying amount of recirculation and exhaust restriction using a fifteen-inch system having a nine-blade impeller and a three-blade tapered turbine. An increase of RPM in the impeller resulted in an increase of RPM in the turbine:

| Impeller RPM | Turbine RPM |
|---|---|
| 2000 | ~450 |
| 3000 | ~500 |
| 5000 | ~550 |

Using the same system, a speed sweep test was performed with wide open recirculation and no exhaust restriction. As above, an increase of RPM in the impeller resulted in an increase of RPM in the turbine:

| Impeller RPM | Turbine RPM |
|---|---|
| 2000 | ~160 |
| 3000 | ~200 |
| 5000 | ~620 |

Further, a heat-up performance test was performed to compare the input brake horsepower (BHP) to the output turbine RPM. An increase in the BHP resulted in and increase of the turbine RPM:

| Input BHP | Turbine RPM |
|---|---|
| 1 | ~200 |
| 2 | ~260 |
| 4 | ~500 |

### Example 2: Twenty-One Blade Impeller with Three Blade Tapered Turbine

A speed sweep test was performed with varying amount of recirculation and exhaust restriction using a fifteen-inch system having a twenty-one blade impeller and a three-blade tapered turbine. An increase of RPM in the impeller resulted in an increase of RPM in the turbine:

| Impeller RPM | Turbine RPM |
|---|---|
| 1000 | ~280 |
| 1500 | ~400 |
| 5000 | ~600 |

Using the same system, a speed sweep test was performed with wide open recirculation and no exhaust restriction. As above, an increase of RPM in the impeller resulted in an increase of RPM in the turbine:

| Impeller RPM | Turbine RPM |
|---|---|
| 1000 | ~240 |
| 1500 | ~400 |
| 2000 | ~600 |

Further, a heat-up performance test was performed to compare the input brake horsepower (BHP) to the output turbine RPM. An increase in the BHP resulted in and increase of the turbine RPM:

| Input BHP | Turbine RPM |
|---|---|
| 1 | ~300 |
| 2 | ~450 |
| 3 | ~600 |

Based on the above examples, the twenty-one blade impeller appeared to create efficient output power, approximately 40 percent higher output power than the nine blade impeller at constant input power. Moreover, cavitation is evident and increases with the number of impeller blades. The twenty-one blade impeller appeared to provide the best overall output and efficiency results to date.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described in the application are to be taken as examples of embodiments. Components may be substituted for those illustrated and described in the application, parts and processes may be reversed, and certain features of the invention may be utilized independently, all as would be apparent to one skilled in the art after having the benefit of this description of the invention. Changes may be made in the elements described in the application without departing from the spirit and scope of the invention as described in the following claims.

1. A system comprising:
an auxiliary turbine;
a drive shaft connected to the auxiliary turbine, said drive shaft extending into a chamber, said chamber configured to hold a fluid;
one or more impellers mounted along the drive shaft within the chamber, said one or more impellers configured to generate cavitation; and
an output turbine coupled to said chamber, wherein said output turbine is configured to capture energy produced by the generated cavitation.

2. The system of claim 1, wherein said auxiliary turbine is within a housing including an exhaust inlet, said exhaust include configured to receiving exhaust energy.

3. The system of claim 1, wherein said chamber is conical-shaped.

4. The system of claim 1, wherein said chamber is L-shaped.

5. The system of claim 1, wherein each impeller includes a front surface having one or more curved blades.

6. The system of claim 1, wherein each impeller includes a back surface that is substantially planar.

7. The system of claim 1, wherein each impeller includes one or more apertures.

8. The system of claim 1, wherein said output turbine is rotatably coupled to the chamber via one or more bearings.

9. The system of claim 1, wherein said output turbine includes one or more ports configured to release fluid from the chamber.

10. The system of claim 1, wherein said output turbine is further coupled to a pulley and gear assembly.

11. The system of claim 1, further comprising one or more inlets for injecting at least one of air and fluid into said chamber.

12. A bladed turbine for generating cavitation comprising:
a substantially circular body defined by an edge;
a front surface;
one or more curved blades extending outwardly from said front surface ;
a back surface, said back surface being substantially flat;
one or more apertures distributed between said curved blades, each aperture including a raised member extending from the front surface; and
an central opening extending from the front surface to the back surface, said opening configured to receive a drive shaft.

13. The impeller of claim 12, wherein a diameter of said body is between about three inches and about fifteen inches.

14. The impeller of claim 12, wherein each blade extends outwardly between about half an inch and about two inches from said front surface.

15. The impeller of claim 12, wherein each blade includes a concave surface and a convex surface.

16. The impeller of claim 12, wherein each blade extends from said opening to said edge.

17. The impeller of claim 12, wherein said central opening further including a dimple for engaging corresponding geometry of the drive shaft.

18. A output turbine for transmitting cavitation generated power comprising:
a top member comprising:
a cylindrical exterior surface;
an interior surface including one or more channels;
one or more bearing mountings within each channel for rotatable movement;
a bottom member comprising:
a core section including a front surface connected to said top member;
one or more fins extending outwardly from an edge of said core section, each fin defined by an elongated section and an abridged section;
wherein the abridged section of each fin includes a port configured to provide an outlet for a fluid.

19. The output turbine of claim 18, wherein the one or more bearings are ball bearings.

20. The output turbine of claim 18, wherein a diameter of the bottom member is greater than a diameter of the top member.
